(19) United States
(12) Patent Application Publication
(10) Pub. No.: US 2025/0081168 A1
(43) Pub. Date: Mar. 6, 2025

(54) SIGNALS FOR ACTIVATOR-TAG POST-TRANSMISSION ORTHOGONALIZATION

(71) Applicant: Nokia Technologies Oy, Espoo (FI)

(72) Inventors: Oana-Elena BARBU, Aalborg (DK); Nuno Manuel KIILERICH PRATAS, Aalborg (DK); Benny VEJLGAARD, Aalborg (DK); Johannes HARREBEK, Aalborg (DK); Simon SVENDSEN, Aalborg (DK)

(21) Appl. No.: 18/820,732

(22) Filed: Aug. 30, 2024

(30) Foreign Application Priority Data
Aug. 30, 2023 (FI) 20235963

(51) Int. Cl. H04W 72/0446; H04W 72/231

(52) U.S. Cl. CPC H04W 72/0446; H04W 72/231

(57) ABSTRACT

A first apparatus configured to: receive a first configuration of one or more candidate slots; receive a second configuration for activation of at least one slot; and transmit at least one activation signal in the at least one activated slot. A second apparatus configured to: receive a first configuration of one or more candidate slots; receive, from a first apparatus, at least one preparation RS; determine at least one slot based, at least partially, on at least one of: the first configuration, or the at least one preparation RS; and transmit a second configuration for activation of the at least one determined slot. A fourth apparatus configured to: transmit, to a first apparatus, a first configuration of one or more candidate slots; and transmit, to a second apparatus associated with a third apparatus, a second configuration of one or more candidate slots.

### TECHNICAL FIELD

The example and non-limiting embodiments relate generally to ambient Internet of Things (A-IoT) devices and, more particularly, to scheduling of activation and reply signals of A-IoT devices.

### BACKGROUND

It is known, in the field of A-IoT, to activate a passive radio with an activation signal.

### SUMMARY

The following summary is merely intended to be illustrative. The summary is not intended to limit the scope of the claims.

In accordance with one aspect, a first apparatus comprising: at least one processor; and at least one memory storing instructions that, when executed by the at least one processor, cause the first apparatus at least to: receive a first configuration of one or more candidate slots; receive a second configuration for activation of at least one slot of the one or more candidate slots; and transmit at least one activation signal in the at least one activated slot.

In accordance with one aspect, a method comprising: receiving, with a first apparatus, a first configuration of one or more candidate slots; receiving a second configuration for activation of at least one slot of the one or more candidate slots; and transmitting at least one activation signal in the at least one activated slot.

In accordance with one aspect, a first apparatus comprising means for: receiving a first configuration of one or more candidate slots; receiving a second configuration for activation of at least one slot of the one or more candidate slots; and transmitting at least one activation signal in the at least one activated slot.

In accordance with one aspect, a non-transitory computer-readable medium comprising program instructions stored thereon for performing at least the following: causing receiving, with a first apparatus, of a first configuration of one or more candidate slots; causing receiving of a second configuration for activation of at least one slot of the one or more candidate slots; and causing transmitting of at least one activation signal in the at least one activated slot.

In accordance with one aspect, a second apparatus comprising: at least one processor; and at least one memory storing instructions that, when executed by the at least one processor, cause the second apparatus at least to: receive a first configuration of one or more candidate slots; receive, from a first apparatus, at least one preparation reference signal; determine at least one slot of the one or more candidate slots based, at least partially, on at least one of: the first configuration, or the at least one preparation reference signal; and transmit a second configuration for activation of the at least one determined slot.

In accordance with one aspect, a method comprising: receiving, with a second apparatus, a first configuration of one or more candidate slots; receiving, from a first apparatus, at least one preparation reference signal; determining at least one slot of the one or more candidate slots based, at least partially, on at least one of: the first configuration, or the at least one preparation reference signal; and transmitting a second configuration for activation of the at least one determined slot.

In accordance with one aspect, a second apparatus comprising means for: receiving a first configuration of one or more candidate slots; receiving, from a first apparatus, at least one preparation reference signal; determining at least one slot of the one or more candidate slots based, at least partially, on at least one of: the first configuration, or the at least one preparation reference signal; and transmitting a second configuration for activation of the at least one determined slot.

In accordance with one aspect, a non-transitory computer-readable medium comprising program instructions stored thereon for performing at least the following: causing receiving, with a second apparatus, of a first configuration of one or more candidate slots; causing receiving, from a first apparatus, of at least one preparation reference signal; determining at least one slot of the one or more candidate slots based, at least partially, on at least one of: the first configuration, or the at least one preparation reference signal; and causing transmitting of a second configuration for activation of the at least one determined slot.

In accordance with one aspect, a fourth apparatus comprising: at least one processor; and at least one memory storing instructions that, when executed by the at least one processor, cause the fourth apparatus at least to: transmit, to a first apparatus, a first configuration of one or more candidate slots; and transmit, to a second apparatus associated with a third apparatus, a second configuration of one or more candidate slots.

In accordance with one aspect, a method comprising: transmitting, with a fourth apparatus to a first apparatus, a first configuration of one or more candidate slots; and transmitting, to a second apparatus associated with a third apparatus, a second configuration of one or more candidate slots.

In accordance with one aspect, a fourth apparatus comprising means for: transmitting, to a first apparatus, a first configuration of one or more candidate slots; and transmitting, to a second apparatus associated with a third apparatus, a second configuration of one or more candidate slots.

In accordance with one aspect, A non-transitory computer-readable medium comprising program instructions stored thereon for performing at least the following: causing transmitting, with a fourth apparatus to a first apparatus, of a first configuration of one or more candidate slots; and causing transmitting, to a second apparatus associated with a third apparatus, of a second configuration of one or more candidate slots.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIGS. 4A and 4B are diagrams illustrating features as described herein;

FIG. 5 is a diagram illustrating features as described herein;

FIG. 6 is a flowchart illustrating steps as described herein;

FIG. 7 is a flowchart illustrating steps as described herein;

FIG. 8 is a diagram illustrating features as described herein;

FIG. 9 is a flowchart illustrating steps as described herein;

FIG. 10 is a flowchart illustrating steps as described herein; and

FIG. 11 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
AIoT or a-IoT ambient Internet of Things
AMF access and mobility management function
ARC activator-reader channel
AT activator-to-tag
BS base station
CE control element
CN core network
CRAN cloud radio access network
CU central unit
D2D device-to-device
DL downlink
DMRS demodulation reference signal
DRX discontinuous reception
DU distributed unit
eMTC enhanced machine-type communication
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDD frequency division duplex
gNB (or gNodeB) base station for 5G/NR, i.e., a node providing NR user plane and control plane protocol terminations towards the UE, and connected via the NG interface to the 5GC
IAB integrated access and backhaul
IE information element
I/F interface
IoT Internet of Things
L1 layer 1
LORA or LoRa long range
LTE long term evolution
MAC medium access control
MME mobility management entity
MT mobile termination
ng or NG new generation
ng-eNB or NG-eNB new generation eNB
NR new radio
N/W or NW network
OFDM orthogonal frequency division multiplex
O-RAN open radio access network
PDCP packet data convergence protocol
PHY physical layer
ProSe proximity service
PSSCH physical sidelink shared channel
PUSCH physical uplink shared channel
RAN radio access network
RedCap reduced capability
RF radio frequency
RFID radio frequency identification
RLC radio link control
RRC radio resource control
RRH remote radio head
RS reference signal
RSU road side unit
RU radio unit
Rx receiver
SCU session control unit
SDAP service data adaptation protocol
SGW serving gateway
SID study item
SINR signal to interference plus noise ratio
SL sidelink
SMF session management function
TDD time division duplex
TSI time-selectivity information
TT tag-to-tag
Tx transmitter
UE user equipment (e.g., a wireless, typically mobile device)
UHF ultra high frequency
UL uplink
UPF user plane function
UWB ultra-wideband
V2I vehicle to infrastructure
V2N vehicle to network
V2P vehicle to pedestrian
V2V vehicle to vehicle
V2X vehicle to everything
VNR virtualized network function

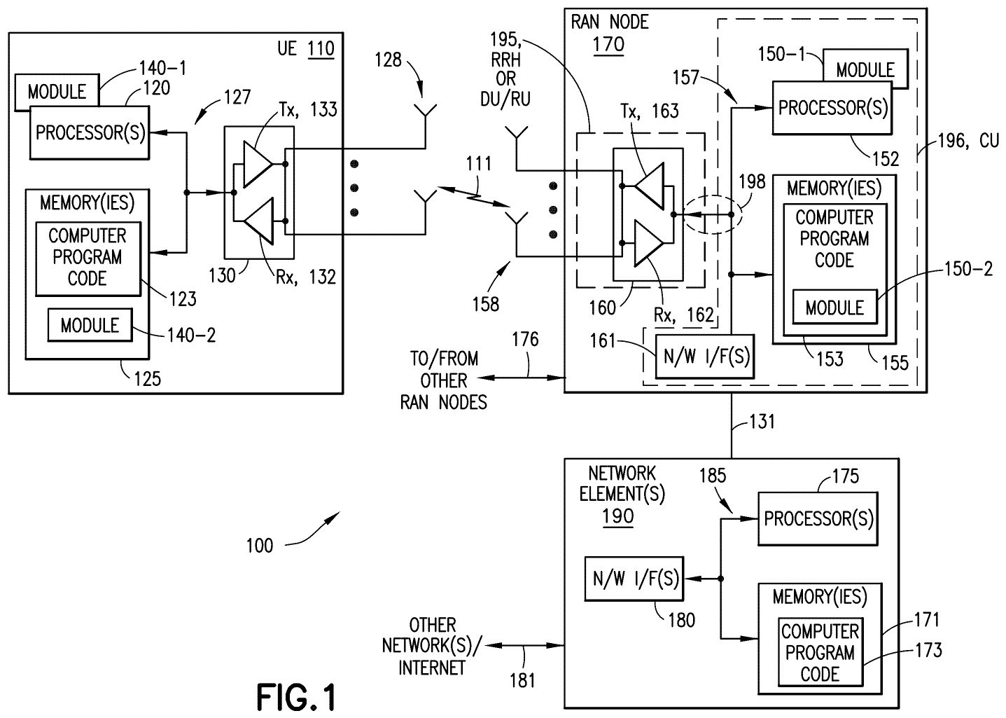

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. FA “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to Internet of Things (IoT) devices, procedures, and/or use cases. Regarding IoT applications, 3GPP has specified NB-IoT/eMTC and NR RedCap before R18 to satisfy the requirements on low cost and low power devices for wide area IoT communication. These IoT devices usually consume tens or hundreds of milliwatts power during transceiving (i.e. transmitting and/or receiving), while the cost is a few dollars. However, to achieve the internet of everything, IoT devices with ten or even a hundred times lower cost and power consumption are needed, especially for a large number of applications requiring battery-less devices.

The number of IoT connections has been growing rapidly in recent years and is predicted to be hundreds of billions by 2030. With more and more ‘things’ expected to be interconnected for improving production efficiency and increasing comforts of life, it demands further reduction of size, cost, and power consumption for IoT devices. In particular, regular replacement of battery for all the IoT devices is impractical due to the tremendous consumption of materials and manpower. It has become a trend to use energy harvested from environments to power IoT devices for self-sustainable communications, especially in applications with a huge number of devices (e.g., ID tags and sensors).

The most critical issue with existing 3GPP technologies for the target use cases (i.e. IoT) is the capability of cooperating with energy harvesting considering limited device size. Cellular devices usually consume tens or even hundreds of milliwatts of power for transceiver processing. Taking the NB-IoT module as an example, the typical current consumption for receive processing is about 60 mA with supply voltage higher than 3.1V, and 70 mA for transmitting processing at 0 dBm transmit power. Furthermore, the output power provided by the typical energy harvester is mostly below 1 milliwatt, considering the small size of a few square centimeters for practical devices. Since the available power is far less than the consumed power, it is impractical to power cellular devices directly by energy harvesting in most cases.

One possible solution is to integrate energy harvesting with rechargeable battery or supercapacitor. However, there are still a few problems to be solved.

Firstly, both rechargeable battery and supercapacitor may suffer from a shortened lifetime in practical cases. It is hard to provide constant charging current or voltage by energy harvesting, while longtime continuous charging is needed due to the very small output power from the energy harvester. Inconstant charging current and longtime continuous charging are both harmful to battery life. For a supercapacitor, its lifetime will be significantly reduced in high temperature environments (e.g., less than 3 years at 50 degrees centigrade).

Secondly, device size will be significantly increased. As a small size button battery can only provide a current of a few tens of milliamps, a battery with a much larger size (e.g., AA battery) is usually used to power cellular devices, whose size can be even larger than the module itself. To store energy for a proper duration of working (e.g., one second), the required capacitance of a supercapacitor is at the level of a hundred mill-farads. The size of such supercapacitors may be larger than an NB-IoT module.

Thirdly, both rechargeable batteries and supercapacitors can be more expensive than the module itself. Even purchased in large quantities, the cost of a suitable battery or supercapacitor may reach one or a few dollars, which nearly doubles the cost of the device.

Radio frequency identification (RFID) is the most well-known technology supporting battery less tags (devices). The power consumption of commercial passive RFID tags can be as low as 1 microwatt. The key techniques enabling such low power consumption are envelope detection for downlink data reception, and backscatter communication for uplink data transmission.

RFID is designed for short-range communications, whose typical effective range is less than 10 meters. As the air interface of RFID almost remains unchanged since 2005, the too-simple transmission scheme becomes an obstacle to improving its link budget and capability of supporting a scalable network.

Attracted by the extremely low power consumption of backscatter communication, many non-3GPP technologies begin to put efforts into related research, such as Wi-Fi, Bluetooth, ultra-wideband (UWB), and long range (LORA). Various research show that a few or tens of microwatts power consumption can be supported for passive tags based on or with small modifications to the above air interfaces.

A significant proportion of the studies target long range communication. Among them, a LoRa tag implemented with commercial off-the-shelf components can send its sensing data to the receiver of 381 meters away. Currently, most of the studies are focusing on independent detailed techniques for various optimization targets. It is hard to see a comprehensive system design fully meeting the requirements of the target use cases (i.e. IoT). However, the standardization of those technologies is agile and quick, as the industries usually follow some de facto standards. Accordingly, many products in the market will follow even a private standard once it shows competitiveness in some applications.

A passive radio is a device that harnesses energy from wireless signals sent on specific carriers and/or bandwidths and charges a simple circuitry that, once activated, will emit/reflect a signal which encodes at least the ID of the passive radio. The typical system architecture around a passive radio consists of:
An activator: a device that sends an activation signal targeted at waking up the passive radio. In the present disclosure, the terms “activator”, “activator radio”, “activation device”, “first apparatus”, and “first radio equipment” may be used interchangeably.
The passive radio: harnesses energy over a range of frequencies and listens for activation signals. Once such a signal is detected, the passive radio emits/reflects a signal which is specific to the radio ID of the passive radio. In the present disclosure, the terms “passive radio”, “tag”, “third radio equipment”, “third apparatus”, “IoT device”, and “a-IoT device” may be used interchangeably. It may be noted that example embodiments of the present disclosure are not limited to passive radios; an a-IoT device may also be a semi-passive radio or an active radio.
A reader: a device that listens and detects the passive radio signals from the passive radio. The reader may or may not be collocated with the activator. A reader (device) may be considered a radio that is configured to detect an a-IoT signal (e.g. tag/reply signal). In the present disclosure, the terms “reader”, “reader radio”, “reader device”, “second apparatus”, and “second radio equipment” may be used interchangeably.

The system architecture around a passive radio may also comprise a session control unit (SCU). In the present disclosure, the terms “SCU” and “fourth apparatus” may be used interchangeably.

A RAN level study item was approved and more recently, in RAN #98-e (RP-223396), the following main two types of devices have been identified:
“ . . . In terms of energy storage, the study will consider the following device characteristics:
   (Passive) Pure batteryless devices with no energy storage capability at all, and completely dependent on the availability of an external source of energy
   (Semi-Passive) Devices with limited energy storage capability that do not need to be replaced or recharged manually.
Device categorization based on corresponding characteristics (e.g. energy source, energy storage capability, passive/active transmission, etc.) may be discussed during the study, in relation with the relevant use cases. The device's peak power consumption shall be limited by its practical form factor for the intended use cases, and shall consider its energy source . . . ”

The objectives of this study item can be grouped into three areas: (i) deployment scenarios; (ii) design targets and (iii) performance assessment. In terms of deployment scenarios, the operation in unlicensed spectrum was highlighted:
“ . . . Identify the suitable deployment scenarios and their characteristics, at least for the use cases/services agreed in SAI's “Study on Ambient power-enabled internet of Things”, comprising among at least the following aspects
   Indoor/outdoor environment
   Basestation characteristics, e.g. macro/micro/pico cells-based deployments
   Connectivity topologies, including which node(s), e.g. basestation, UE, relay, repeater, etc. can communicate with target devices
   TDD/FDD, and frequency bands in licensed or unlicensed spectrum
   Coexistence with UEs and infrastructure in frequency bands for existing 3GPP technologies
   Device originated and/or device terminated traffic assumption
      NOTE: There can be more than one deployment scenario identified for a use case, and a deployment scenario may be common to more than one use case.
      NOTE: Where more than one deployment scenario is identified for a use case, the trade-offs between them should also be studied.
      NOTE: The study shall not prioritize deployment aspects that should be coordinated with SA, e.g. public or private network, with or without CN connection.
      NOTE: A representative use case can be studied for a group of use cases that have similar requirements . . . ”

In RAN #98e & #99, it was agreed to focus on three device types: Device A: Passive device with NO energy storage; Device B: Passive device with energy storage; and Device C: active device with energy storage. The design targets for power consumption are: Device A≤10 μW; Device A<Device B<Device C; and Device C≤1 mW. The device complexity design targets are: Device A: Comparable to UHF RFID; Device A≤Device B≤Device C; and Device C: Orders-of-magnitude lower than NB-IoT. During RAN #99, the Rapporteur listed the following functionalities that need to be tackled for Ambient IoT in RAN:
“ . . . Rapporteur: Assumptions on potentially required functionality to be supported need to be identified for Ambient IoT in RAN. To avoid detailed WG-level analysis, the potential functionalities are expected to be general and to meet the RAN design targets for Ambient IoT air interface. The following potential assumed RAN functionalities were found in the submitted papers (please refer also to design targets above).
   Security (authentication, encryption, data integrity, authorization)
   Positioning/localization/ranging
   Support of channel access regulations associated with unlicensed spectrum.
   Coexistence with legacy systems, devices, and network deployments
   Energy harvesting signals, and/or use of legacy signals for energy harvesting
   Identification and management of devices
   Possibility of CN connection, including for sporadic and opportunistic small data between device and core
      Suggest to send LS to SA on feasibility of solutions with/without CN
   Backscattering modulation
   Envelope detection in receiver
   Non-OFDM waveform in DL, robust against low-accuracy receiver architecture
   Compact protocol layers design
   Anti-collision methods/random access procedure/tag-reaction load distribution
   Interference mitigation (intra-reader, inter-reader, reader-cellular network)
   For topology (1) and (2), gNB/UE/intermediate node may need limited full-duplex capability
   Mobility management procedures
   Communicate with all, a subset, or one of the Ambient IoT devices present
   Activation, deactivation of ambient IoT device
   NW configuration of signals and channels for communication with Ambient IoT devices
   Control of when tag reflects/reacts to a received signal when addressed
   DRX
   Synchronization scheme robust against low-accuracy receiver architecture
   Coverage enhancement techniques with low device complexity . . . ”

In TR 38.848, the following connectivity topologies for ambient IoT (A-IoT) networks and devices were defined for the purposes of the study. In all these topologies, the ambient IoT device may be provided with a carrier wave from other node(s) either inside or outside the topology. The links in each topology may be bidirectional or unidirectional. Base stations (BS), UE, assisting node, or intermediate node could be multiple BSs or UEs, respectively. The mixture of indoor and outdoor placement of such nodes is regarded as a network implementation choice.

Ambient IoT devices may be described as low power devices, low cost devices, and/or as devices with limited functionality/processing capability. An example of an ambient IoT (A-IoT) device is a passive radio, which may harness energy from wireless signals sent on specific carriers and/or bandwidths and charge a simple circuitry that, once activated, may emit/reflect a signal, which may encode at least the ID of the passive radio. Other examples of A-IoT devices include semi-passive devices, battery-less devices, and low cost simplified mobile devices. A-IoT devices may be used, for example, for indoor/outdoor positioning.

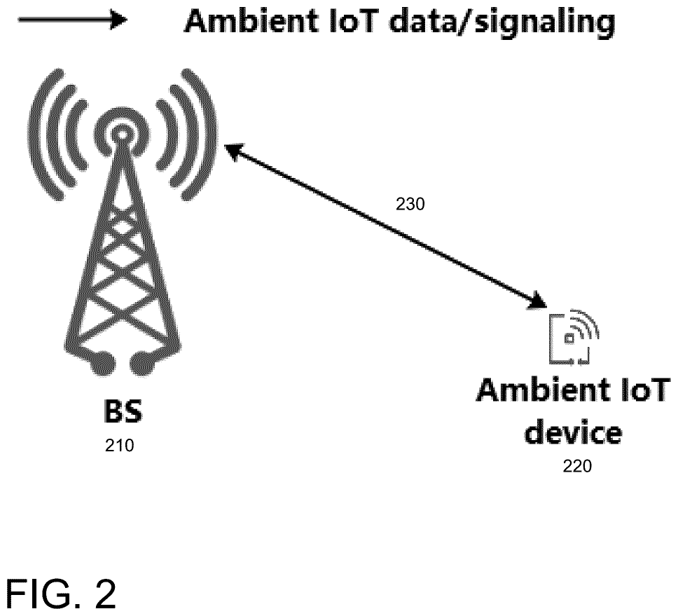

Referring now to FIG. 2, illustrated is an example of Topology 1: BS<->AIoT device. In Topology 1, the ambient IoT device (220) directly and bidirectionally communicates (230) with a base station (210). The communication between the base station (210) and the ambient IoT device (220) includes ambient IoT data and/or signalling (230). This topology includes the possibility that the BS transmitting to the ambient IoT device is different from the BS receiving from the ambient IoT device.

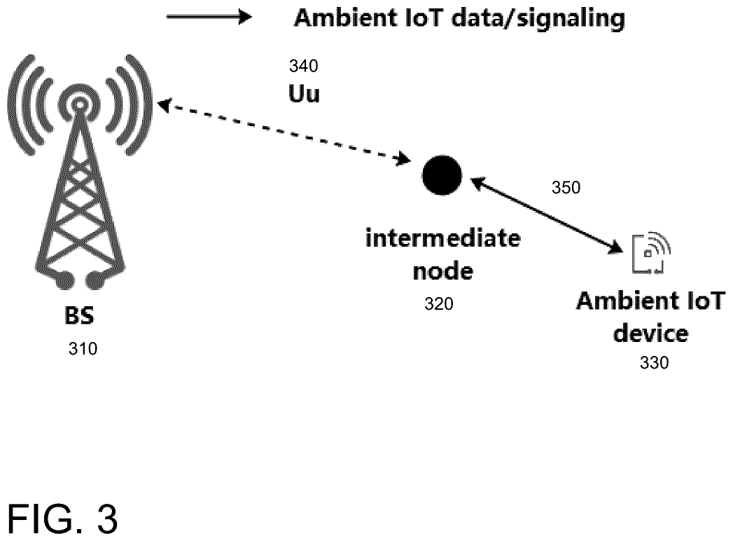

Referring now to FIG. 3, illustrated is an example of Topology 2: BS<->intermediate node<->AIoT device. In Topology 2, the ambient IoT device (330) communicates bidirectionally (350) with an intermediate node (320) between the device (330) and the base station (310). In this topology, the intermediate node (320) can be a relay, integrated access and backhaul (IAB) node, UE, repeater, etc. which is capable of ambient IoT. The intermediate node (320) transfers the information (340) between the BS (310) and the ambient IoT device (330).

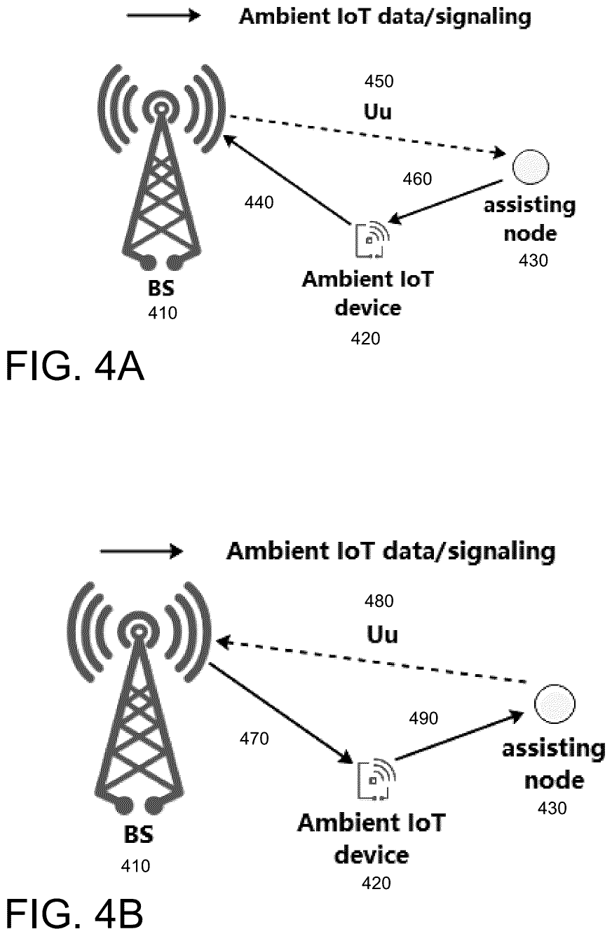

Referring now to FIGS. 4A and 4B, illustrated is examples of Topology 3: BS<->assisting node<->AIoT device<->BS device. In Topology 3, the ambient IoT device (420) transmits data/signaling (440) to a base station (410) and receives data/signaling (460) from the assisting node (430) (as in FIG. 4A); or the ambient IoT device (420) receives data/signaling (470) from a base station (410) and transmits data/signaling (490) to the assisting node (430) (as in FIG. 4B). In this topology, the assisting node (430) can be a relay, IAB, UE, repeater, etc. which is capable of ambient IoT, and either receives data/signaling (450) from the base station (410) (as in FIG. 4A) or transmits data/signaling to the base station (410) (as in FIG. 4B).

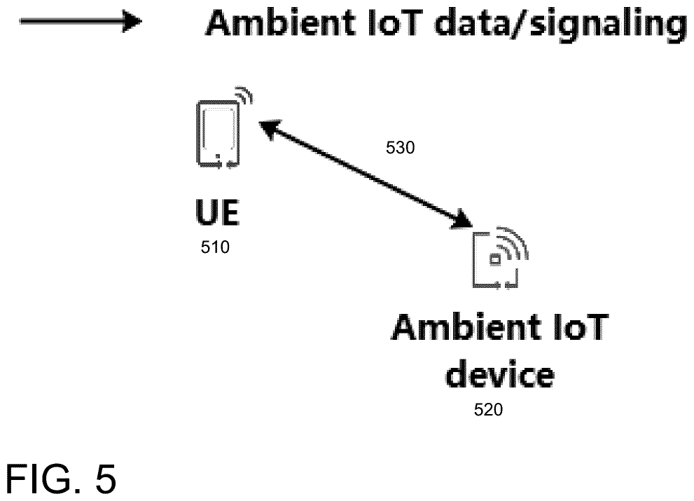

Referring now to FIG. 5, illustrated is an example of Topology 4: UE<->AIoT device. In Topology 4, the ambient IoT device (520) communicates bidirectionally (530 with a UE (510). The communication (530) between the UE (510) and the ambient IoT device (520) includes ambient IoT data and/or signaling.

Reading an ambient IoT device (which may be referred to as a tag in the present disclosure) is a challenging task due to the inherent nature of the passive radio. More precisely, the passive radio does not have an independent power source, is most often mobile, and can hear other radios only in its own proximity (most often with a 5-10 m radius) due to the low complexity receiver. For these reasons, the tags cannot perform typical initial access procedures (e.g. paging response, random access and neighbor cell monitoring procedures, etc.). Furthermore, introduction of new tags in the area, their mobility, data collection and transmission capability should be transparent to the NR NW. Because of the above limitations, the NR NW cannot apply the typical NR UE paging operations, and alternatives need to be defined.

The NR NW can read (i.e. receive/decode data/signaling from) the tag only if the tag hears an activation signal loud enough so that: it can charge sufficiently; and it can generate a (reply) signal (in response to the activation signal) that is loud enough to be heard by another nearby NW element (a gNB, RSU, UE, etc., typically located no more than approximately 100 m away).

Enabling loud enough signal generation is not trivial due to the following aspects:
Multiple tags may reply on the same time-frequency resources, thus interfering with each other during their response. This type of interference is called tag-to-tag (TT) interference and it affects the ability of the reader to distinguish between tags which respond concurrently by using the same time-frequency resources.
Tags typically reply/reflect on the same carrier as that used by the activation signal. Since the activation signal may be several orders of magnitude stronger than the tag reply, the phenomenon called activator-to-tag (AT) interference may occur. In other words, the tag reply may be drowned by the activation signal, affecting detection and reading of the tag; the reader must be able to isolate the activation signal before attempting to detect the tag.

A technical effect of example embodiments of the present disclosure may be to enable reading of an ambient IoT tag suffering from activator-to-tag (AT) interference in a 5G NR NW.

In an example embodiment, the activator and the reader may be configured such that the activation signal and the reply signal may be combined orthogonally. A technical effect of example embodiments of the present disclosure may be to improve the signal to interference plus noise ratio (SINR).

In the present disclosure, the terms “reply signal”, “signal from an a-IoT device”, and “tag signal” may be used interchangeably.

In an example embodiment, the activation signal may be aligned away from the tag signal. In an example embodiment, the reader may be enabled to learn the channel response and time-selectivity (e.g. channel behavior) between itself and the activator. In an example embodiment, the reader may be enabled to use the channel response information and/or time-selectivity information to obtain a baseband combiner. The baseband combiner may be obtained so that either: the post-processed activation signal and the one or more tag signals lie in orthogonal spaces and thus the tag signal becomes distinguishable from the activation signal; or the activation signal is suppressed at the reader side (i.e. from the reader's perspective).

In an example embodiment, a preparation step may be included in the tag reading session, in which the activator and reader may communicate with each other, for example while all tags within reach of the activator remain silent. To this end, a preparation reference signal may be exchanged between the activator and reader. Note that this preparation signal may not be configured to trigger any tag; therefore its signature may be designed in such a way that it does not coincide with a tag activation signal.

In an example embodiment, the preparation signaling may happen shortly (where short refers to a duration within the channel coherence time) before the tag reading session, for example so that the activator-reader channel acquired during the preparation step may be used to orthogonalize the two signals. In an example embodiment, a set of pre-configured slots may be reserved for potential activation, for example to determine how fast the reading has to be triggered after the preparation step. The set of pre-configured slots may comprise slot(s) in which an activation signal may be transmitted. In an example embodiment, a unique slot may be selected for the actual transmission, for example based on the outcome of the preparation step and the reader's processing capabilities.

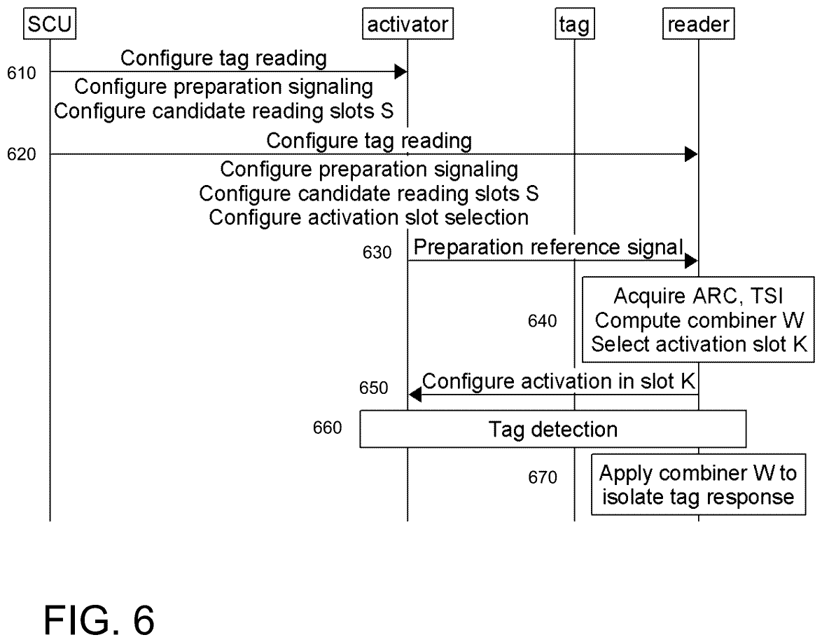

Referring now to FIG. 6, illustrated is a flowchart according to example embodiments of the present disclosure. At 610 and 620, a preparation step may be performed. A session control unit (SCU) may pre-configure the activator (610) and reader (620) for tag reading (i.e. activating the tag, the tag transmitting the reply, and the reader detecting the reply). For example, the pre-configuration may be performed via a new RRC information element (IE) or MAC control element (CE). The SCU may also pre-configure a set S of potential activation slots (i.e., slots in which the activator may send an activation signal). The SCU may designate the reader to select one of the activation slots after the preparation step is completed. For example, the SCU may give a list of potential slots, and the reader may book/choose/select one of the listed slots. The reader may send the index of the booked slot to the activator. The activator may be alerted by the SCU that the reader will make this selection. In other words, the activator may know (i.e. have been informed) that the second configuration may be transmitted by the reader, and so may expect, monitor for, detect, determine, observe, and/or receive the second configuration.

At 630, the activator may send a reference signal to the reader. The reference signal may be a preparation reference signal. Note that this reference signal may be activator specific, with a known code, bandwidth, and carrier (e.g., similar to DMRS, Gold codes or Zadoff-Chu sequences in NR systems), whereby it may be understood as pre-agreed or pre-configured by the SCU. For example, the preparation reference signal may be configured to identify the activator. The reader, when receiving the reference signal, may also determine if additional transmission(s) of the reference signal are needed in order for it to obtain a reliable estimation of the activator-reader channel. For example, the reader may request additional transmission(s) of the preparation reference signal. Alternatively, the activator may repeat transmission of the preparation reference signal until it has received an indication to stop. How additional transmission(s) of the preparation reference signal are achieved may depend on whether the SCU requested explicit feedback about the outcome of the preparation session from the reader.

At 640, the reader may reconstruct the activator-reader channel (ARC). Additionally or alternatively, the reader may determine the time-selectivity information (TSI) of ARC. For example, the reader may compute a maximum Doppler shift f_{D}, and define TSI as the coherence time of the channel

$${t}_{c} \approx \frac{0.4}{{f}_{D}} .$$

Additionally or alternatively, the reader may compute a combiner W that suppresses the activation signal as seen by the reader. Note that if the channel tag-reader is partly known (e.g., has been previously acquired), then a combiner that orthogonalizes the activation and tag signals may instead be computed. Additionally or alternatively, the reader may use the TSI to select a slot K for activation, from the pre-configured set S. As an example, slot K may be selected using the following rule: “select the smallest K, conditioned on K<=(TSI-tp)/Ts, where Ts is the slot duration and tp is the reception time of preparation signal.”

At 650, the reader may send the index K of the selected slot to the activator. This may be transmitted via an RRC IE or a MAC CE. The transmission of an indication of the selected slot may configure the activator to wake the tag up.

The activator may receive the configuration from the reader and transmit the activation signal. The activation signal may be transmitted by the activator based on the configuration (i.e. index K of the selected slot) received from the reader.

The tag may wake up upon hearing the activation and starts transmitting its reply.

The reader may receive the combination of the two signals (activation signal and reply to activation signal) and apply the obtained combiner W to move the two signals into orthogonal spaces, at 670. The reader may then proceed to decode the tag signal only, at 660.

In an alternative example embodiment, the reader may report slot K to the SCU (in contrast to 650) and the SCU may trigger the tag detection accordingly. Depending on where the SCU resides, the reporting may be done over: uplink (UL) physical uplink shared channel (PUSCH) if the SCU resides in the NW; or sidelink (SL) physical sidelink shared channel (PSSCH) if the SCU resides in another UE.

The tag detection may be performed as follows. The SCU may select the activator-reader and configure them for activating-reading the tag with ID X. The activator may send a tag-specific activation signal. The tag may hear the activation and start replying with a tag-specific reply. The tag-specific reply may be heard by the reader and decoded. The reader may send the tag contents to the SCU.

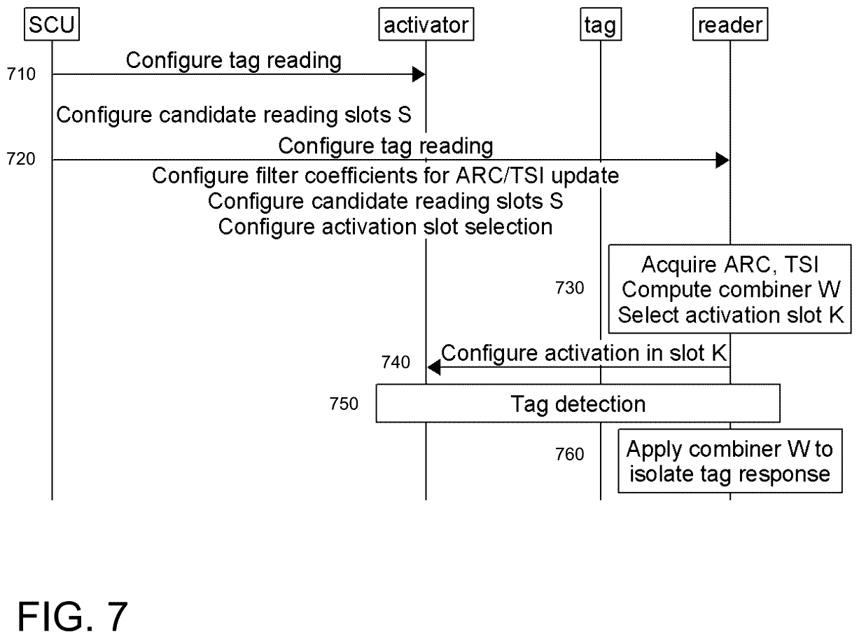

Referring now to FIG. 7, illustrated is a flowchart according to another alternative example embodiment of the present disclosure. At 710 and 720, the SCU may configure the activator and/or reader with a set of instructions on how to update its most recent ARC/TCI estimates, and thus forego the need for a preparation step altogether. For example, if the SCU has configured a preparation signal in the last Dt seconds, and the SCU is aware of the mobility profile of the activator-reader, then the SCU may instruct the reader on how to update its ARC and TSI. For example, the SCU may send a filter type and coefficient(s) that instructs the reader on how to utilize past ARCs to compute the current ARC. At 730, the reader may acquire ARC. Additionally or alternatively, the reader may acquire TSI. Additionally or alternatively, the reader may compute a combiner W. Additionally or alternatively, the reader may select an activation slot K. At 740, the reader may configure the activator for activation in slot K. At 750, tag detection may be performed between the activator, the tag, and the reader. At 760, the reader may apply combiner W to isolate the tag response.

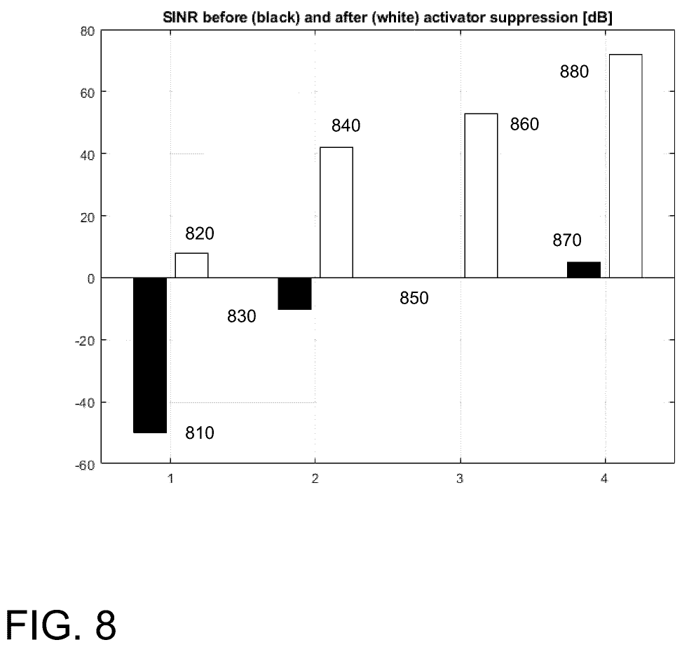

Referring now to FIG. 8, illustrated is an example of SINR of the tag before (810, 830, 850, 870) and after (820, 840, 860, 880) post-alignment of the activation signal, which may illustrate a potential technical effect of example embodiments of the present disclosure (i.e. aligning the activation signal away from the tag signal via a zero-forcing combiner determination and application in the reader). In the example of FIG. 8, the reader may be equipped with 64 receive antennas. It may be observed that the orthogonalization may be successful even in very low tag-to-activation SINR regimes. For example, for tag SINR of −50 dB, the application of the combiner at the reader may increase the post-processing SINR to 5 dB. Note that, for simplicity, FIG. 8 considers ideal ARC acquisition at the reader.

Example embodiments of the present disclosure may be implemented with respect to IAB nodes. An IAB node consists, logically, of a Mobile Termination (MT) (e.g. IAB MT) that communicates with upstream nodes, and a RAN component, such as a Distributed Unit (DU) (e.g. IAB DU), that communicates with downstream IAB nodes or subscriber UEs 110. In NR/5G, a gNB may comprise a split architecture in which a centralized unit (CU) and a distributed unit (DU) each perform a subset of the functionalities of the gNB. In other words, the MT part of an IAB node may be used to communicate with a parent node, and the DU part of an IAB node may be used to communicate with a child node or UE. A mobile termination (MT) of an IAB node may communicate with a parent node, such as IAB donor. The IAB donor may comprise the centralized unit of the gNB and may also comprise the distributed unit. A distributed unit (DU) of an IAB node may communicate with a child node or a user equipment.

Example embodiments of the present disclosure may be implemented with respect to SL devices. SL devices may be used to provide communication between a vehicle and a network, infrastructure(s), other vehicle(s), or other road user(s) in the surrounding/immediate area. Such communication may enable proximity service (ProSe), or transmission of information about the surrounding environment, between devices in close proximity, for example device-to-device (D2D) communication technology. Such direct communication may be available even when network coverage is unavailable. Additionally or alternatively, NR SL methods may be implemented in scenarios unrelated to traffic users, such as public safety scenarios and/or commercial scenarios. SL use cases may relate to Internet of Things (IoT) and automotive industries (e.g., for reduction of accident risk and safer driving experiences). These use cases may include a message exchange among vehicles (V2V), vehicles and pedestrians (V2P), vehicles and infrastructure (V2I) and vehicles and networks (V2N), and may be referred to as vehicle-to-everything (V2X). The allocation of V2V resources in cellular, i.e., time and frequency resources, can be either controlled by the cellular network structure or performed autonomously by the individual vehicles (e.g. UE devices thereof). Sidelink may use same or different carrier frequencies or frequency bands than cellular communication.

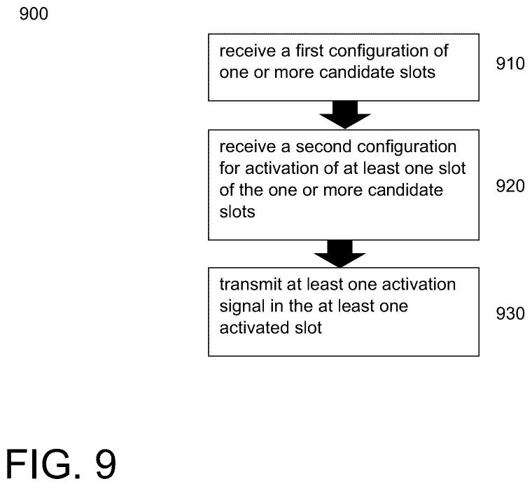

FIG. 9 illustrates the potential steps of an example method 900. The example method 900 may include: receiving a first configuration of one or more candidate slots, 910; receiving a second configuration for activation of at least one slot of the one or more candidate slots, 920; and transmitting at least one activation signal in the at least one activated slot, 930. The example method 900 may be performed, for example, with an activator, an activator radio, an activation device, an activator device, a UE configured to activate an a-IoT device, a first radio equipment, a first apparatus, etc.

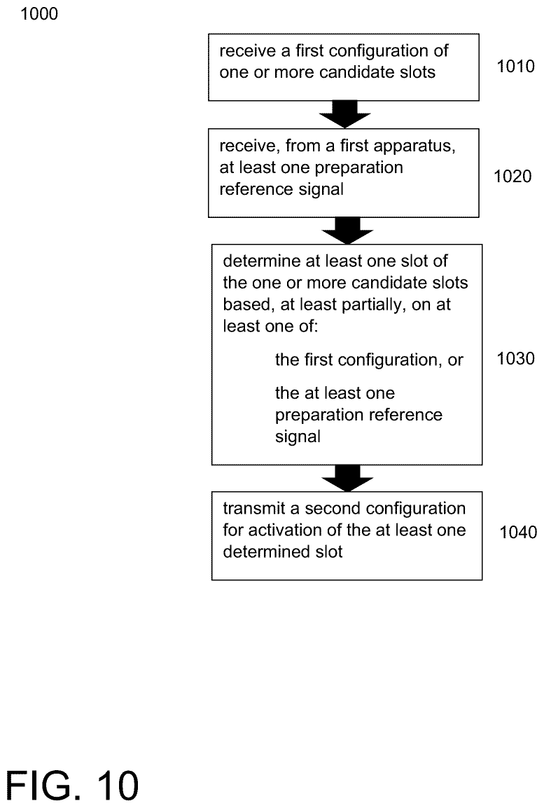

FIG. 10 illustrates the potential steps of an example method 1000. The example method 1000 may include: receiving a first configuration of one or more candidate slots, 1010; receiving, from a first apparatus, at least one preparation reference signal, 1020; determining at least one slot of the one or more candidate slots based, at least partially, on at least one of: the first configuration, or the at least one preparation reference signal, 1030; and transmitting a second configuration for activation of the at least one determined slot, 1040. The example method 1000 may be performed, for example, with a reader, a reader radio, a reader device, a radio that is configured to detect an a-IoT signal, a second radio equipment, a second apparatus, etc.

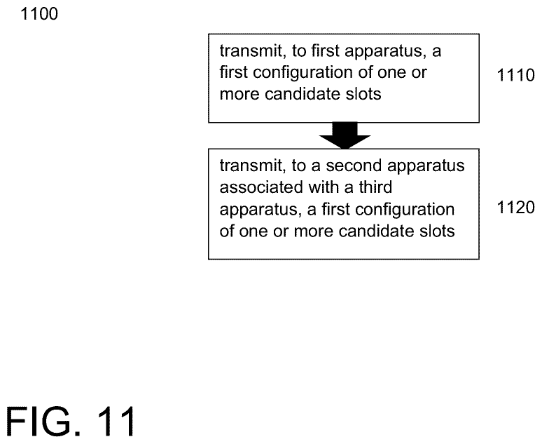

FIG. 11 illustrates the potential steps of an example method 1100. The example method 1100 may include: transmitting, to a first apparatus, a first configuration of one or more candidate slots, 1110; and transmitting, to a second apparatus associated with a third apparatus, a second configuration of one or more candidate slots, 1120. The example method 1100 may be performed, for example, with a SCU, a fourth apparatus, etc.

In the present disclosure, an activator may be referred to as a first apparatus. In the present disclosure, a reader may be referred to as a second apparatus. In the present disclosure, a tag/IoT device may be referred to as a third apparatus.

In accordance with one example embodiment, an apparatus may comprise: at least one processor; and at least one memory storing instructions that, when executed by the at least one processor, cause the apparatus at least to: receive a first configuration of one or more candidate slots; receive a second configuration for activation of at least one slot of the one or more candidate slots; and transmit at least one activation signal in the at least one activated slot.

The example apparatus may be a first apparatus, and may comprise an activator.

The example apparatus may be further configured to: transmit, to a second apparatus, at least one preparation reference signal based, at least partially, on the first configuration.

The at least one preparation reference signal may identify the first apparatus.

The first configuration may comprise a configuration for the at least one preparation reference signal.

The second configuration may comprise, at least, an index of the at least one slot.

The first configuration may comprise, at least, an indication to monitor for the second configuration.

The first configuration may be received via at least one of: a radio resource control information element, or a medium access control message.

The second configuration may be received via at least one of: a radio resource control information element, or a medium access control message.

The first configuration may be received from a session control unit.

The at least one activation signal may be transmitted to a third apparatus associated with the first apparatus.

The third apparatus may comprise a tag.

The second configuration may be received from a second apparatus associated with the first apparatus.

The second apparatus may comprise a reader.

In accordance with one aspect, an example method may be provided comprising: receiving, with a first apparatus, a first configuration of one or more candidate slots; receiving a second configuration for activation of at least one slot of the one or more candidate slots; and transmitting at least one activation signal in the at least one activated slot.

The first apparatus may comprise an activator.

The example method may further comprise: transmitting, to a second apparatus, at least one preparation reference signal based, at least partially, on the first configuration.

The at least one preparation reference signal may identify the first apparatus.

The first configuration may comprise a configuration for the at least one preparation reference signal.

The second configuration may comprise, at least, an index of the at least one slot.

The first configuration may comprise, at least, an indication to monitor for the second configuration.

The first configuration may be received via at least one of: a radio resource control information element, or a medium access control message.

The second configuration may be received via at least one of: a radio resource control information element, or a medium access control message.

The first configuration may be received from a session control unit.

The at least one activation signal may be transmitted to a third apparatus associated with the first apparatus.

The third apparatus may comprise a tag.

The second configuration may be received from a second apparatus associated with the first apparatus.

The second apparatus may comprise a reader.

In accordance with one example embodiment, an apparatus may comprise: circuitry configured to perform: receiving a first configuration of one or more candidate slots; circuitry configured to perform: receiving a second configuration for activation of at least one slot of the one or more candidate slots; and circuitry configured to perform: transmitting at least one activation signal in the at least one activated slot.

In accordance with one example embodiment, an apparatus may comprise: processing circuitry; memory circuitry including computer program code, the memory circuitry and the computer program code configured to, with the processing circuitry, enable the apparatus to: receive a first configuration of one or more candidate slots; receive a second configuration for activation of at least one slot of the one or more candidate slots; and transmit at least one activation signal in the at least one activated slot.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: receiving a first configuration of one or more candidate slots; receiving a second configuration for activation of at least one slot of the one or more candidate slots; and transmitting at least one activation signal in the at least one activated slot.

The apparatus may comprise a first apparatus, and may comprise an activator.

The means may be further configured for: transmitting, to a second apparatus, at least one preparation reference signal based, at least partially, on the first configuration.

The at least one preparation reference signal may identify the first apparatus.

The first configuration may comprise a configuration for the at least one preparation reference signal.

The second configuration may comprise, at least, an index of the at least one slot.

The first configuration may comprise, at least, an indication to monitor for the second configuration.

The first configuration may be received via at least one of: a radio resource control information element, or a medium access control message.

The second configuration may be received via at least one of: a radio resource control information element, or a medium access control message.

The first configuration may be received from a session control unit.

The at least one activation signal may be transmitted to a third apparatus associated with the first apparatus.

The third apparatus may comprise a tag.

The second configuration may be received from a second apparatus associated with the first apparatus.

The second apparatus may comprise a reader.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause receiving, with a first apparatus, of a first configuration of one or more candidate slots; cause receiving of a second configuration for activation of at least one slot of the one or more candidate slots; and cause transmitting of at least one activation signal in the at least one activated slot.

In accordance with one example embodiment, a non-transitory computer-readable medium comprising program instructions stored thereon for performing at least the following: causing receiving, with a first apparatus, of a first configuration of one or more candidate slots; causing receiving of a second configuration for activation of at least one slot of the one or more candidate slots; and causing transmitting of at least one activation signal in the at least one activated slot.

In accordance with another example embodiment, a non-transitory program storage device readable by a machine may be provided, tangibly embodying instructions executable by the machine for performing operations, the operations comprising: causing receiving, with a first apparatus, of a first configuration of one or more candidate slots; causing receiving of a second configuration for activation of at least one slot of the one or more candidate slots; and causing transmitting of at least one activation signal in the at least one activated slot.

In accordance with another example embodiment, a non-transitory computer-readable medium comprising instructions that, when executed by an apparatus, cause the apparatus to perform at least the following: causing receiving, with a first apparatus, of a first configuration of one or more candidate slots; causing receiving of a second configuration for activation of at least one slot of the one or more candidate slots; and causing transmitting of at least one activation signal in the at least one activated slot.

A computer implemented system comprising: at least one processor and at least one non-transitory memory storing instructions that, when executed by the at least one processor, cause the system at least to perform: causing receiving, with a first apparatus, of a first configuration of one or more candidate slots; causing receiving of a second configuration for activation of at least one slot of the one or more candidate slots; and causing transmitting of at least one activation signal in the at least one activated slot.

A computer implemented system comprising: means for causing receiving, with a first apparatus, of a first configuration of one or more candidate slots; means for causing receiving of a second configuration for activation of at least one slot of the one or more candidate slots; and means for causing transmitting of at least one activation signal in the at least one activated slot.

In accordance with one example embodiment, an apparatus may comprise: at least one processor; and at least one memory storing instructions that, when executed by the at least one processor, cause the apparatus at least to: receive a first configuration of one or more candidate slots; receive, from a first apparatus, at least one preparation reference signal; determine at least one slot of the one or more candidate slots based, at least partially, on at least one of: the first configuration, or the at least one preparation reference signal; and transmit a second configuration for activation of the at least one determined slot.

The example apparatus may comprise a second apparatus, and may comprise a reader.

The first apparatus may comprise an activator.

The at least one preparation reference signal may identify the first apparatus.

The second configuration may comprise, at least, an index of the at least one determined slot.

The first configuration may comprise at least one of: an indication to monitor for the at least one preparation reference signal, or a configuration for determining the at least one slot.

The first configuration may be received via at least one of: a radio resource control information element, or a medium access control message.

The second configuration may be transmitted via at least one of: a radio resource control information element, or a medium access control message.

The first configuration may be received from a session control unit.

The second configuration may be transmitted to at least one of: the first apparatus, or a session control unit.

Determining the at least one slot may comprise the example apparatus may be further configured to: determine one or more conditions of a channel between the first apparatus and the second apparatus; determine a combiner configured to at least one of: minimize a contribution of at least one activation signal in at least one of the one or more candidate slots, or isolate the at least one activation signal in the at least one of the one or more candidate slots; and determine the at least one slot based, at least partially, on the one or more determined channel conditions.

The example apparatus may be further configured to: monitor for the at least one activation signal in the at least one determined slot; monitor for at least one reply to the at least one activation signal from a third apparatus associated with the second apparatus; apply the determined combiner to the at least one activation signal and the at least one reply; and detect the third apparatus based, at least partially, on the application of the determined combiner to the at least one activation signal and the at least one reply.

The third apparatus may comprise a tag.

The example apparatus may be further configured to: report contents of the detected third apparatus to a session control unit.

The first configuration may further comprise at least one of: a configuration for updating at least one estimate of a channel between the first apparatus and the second apparatus, or a configuration for updating at least one time-selectivity information associated with the channel.

In accordance with one aspect, an example method may be provided comprising: receiving, with a second apparatus, a first configuration of one or more candidate slots; receiving, from a first apparatus, at least one preparation reference signal; determining at least one slot of the one or more candidate slots based, at least partially, on at least one of: the first configuration, or the at least one preparation reference signal; and transmitting a second configuration for activation of the at least one determined slot.

The second apparatus may comprise a reader.

The first apparatus may comprise an activator.

The at least one preparation reference signal may identify the first apparatus.

The second configuration may comprise, at least, an index of the at least one determined slot.

The first configuration may comprise at least one of: an indication to monitor for the at least one preparation reference signal, or a configuration for determining the at least one slot.

The first configuration may be received via at least one of: a radio resource control information element, or a medium access control message.

The second configuration may be transmitted via at least one of: a radio resource control information element, or a medium access control message.

The first configuration may be received from a session control unit.

The second configuration may be transmitted to at least one of: the first apparatus, or a session control unit.

The determining of the at least one slot may comprise: determining one or more conditions of a channel between the first apparatus and the second apparatus; determining a combiner configured to at least one of: minimize a contribution of at least one activation signal in at least one of the one or more candidate slots, or isolate the at least one activation signal in the at least one of the one or more candidate slots; and determining the at least one slot based, at least partially, on the one or more determined channel conditions.

The example method may further comprise: monitoring for the at least one activation signal in the at least one determined slot; monitoring for at least one reply to the at least one activation signal from a third apparatus associated with the second apparatus; applying the determined combiner to the at least one activation signal and the at least one reply; and detecting the third apparatus based, at least partially, on the application of the determined combiner to the at least one activation signal and the at least one reply.

The third apparatus may comprise a tag.

The example method may further comprise: reporting contents of the detected third apparatus to a session control unit.

The first configuration may further comprise at least one of: a configuration for updating at least one estimate of a channel between the first apparatus and the second apparatus, or a configuration for updating at least one time-selectivity information associated with the channel.

In accordance with one example embodiment, an apparatus may comprise: circuitry configured to perform: receiving a first configuration of one or more candidate slots; circuitry configured to perform: receiving, from a first apparatus, at least one preparation reference signal; circuitry configured to perform: determining at least one slot of the one or more candidate slots based, at least partially, on at least one of: the first configuration, or the at least one preparation reference signal; and circuitry configured to perform: transmitting a second configuration for activation of the at least one determined slot.

In accordance with one example embodiment, an apparatus may comprise: processing circuitry; memory circuitry including computer program code, the memory circuitry and the computer program code configured to, with the processing circuitry, enable the apparatus to: receive a first configuration of one or more candidate slots; receive, from a first apparatus, at least one preparation reference signal; determine at least one slot of the one or more candidate slots based, at least partially, on at least one of: the first configuration, or the at least one preparation reference signal; and transmit a second configuration for activation of the at least one determined slot.

In accordance with one example embodiment, an apparatus may comprise means for: receiving a first configuration of one or more candidate slots; receiving, from a first apparatus, at least one preparation reference signal; determining at least one slot of the one or more candidate slots based, at least partially, on at least one of: the first configuration, or the at least one preparation reference signal; and transmitting a second configuration for activation of the at least one determined slot.

The apparatus may comprise a second apparatus, and may comprise a reader.

The first apparatus may comprise an activator.

The at least one preparation reference signal may identify the first apparatus.

The second configuration may comprise, at least, an index of the at least one determined slot.

The first configuration may comprise at least one of: an indication to monitor for the at least one preparation reference signal, or a configuration for determining the at least one slot.

The first configuration may be received via at least one of: a radio resource control information element, or a medium access control message.

The second configuration may be transmitted via at least one of: a radio resource control information element, or a medium access control message.

The first configuration may be received from a session control unit.

The second configuration may be transmitted to at least one of: the first apparatus, or a session control unit.

The means configured for determining the at least one slot may comprise means configured for: determining one or more conditions of a channel between the first apparatus and the second apparatus; determining a combiner configured to at least one of: minimize a contribution of at least one activation signal in at least one of the one or more candidate slots, or isolate the at least one activation signal in the at least one of the one or more candidate slots; and determining the at least one slot based, at least partially, on the one or more determined channel conditions.

The means may be further configured for: monitoring for the at least one activation signal in the at least one determined slot; monitoring for at least one reply to the at least one activation signal from a third apparatus associated with the second apparatus; applying the determined combiner to the at least one activation signal and the at least one reply; and detecting the third apparatus based, at least partially, on the application of the determined combiner to the at least one activation signal and the at least one reply.

The third apparatus may comprise a tag.

The means may be further configured for: reporting contents of the detected third apparatus to a session control unit.

The first configuration may further comprise at least one of: a configuration for updating at least one estimate of a channel between the first apparatus and the second apparatus, or a configuration for updating at least one time-selectivity information associated with the channel.

In accordance with one example embodiment, a non-transitory computer-readable medium comprising instructions stored thereon which, when executed with at least one processor, cause the at least one processor to: cause receiving, with a second apparatus, of a first configuration of one or more candidate slots; cause receiving, from a first apparatus, of at least one preparation reference signal; determine at least one slot of the one or more candidate slots based, at least partially, on at least one of: the first configuration, or the at least one preparation reference signal; and cause transmitting of a second configuration for activation of the at least one determined slot.

In accordance with one example embodiment, a non-transitory computer-readable medium comprising program instructions stored thereon for performing at least the following: causing receiving, with a second apparatus, of a first configuration of one or more candidate slots; causing receiving, from a first apparatus, of at least one preparation reference signal; determining at least one slot of the one or more candidate slots based, at least partially, on at least one of: the first configuration, or the at least one preparation reference signal; and causing transmitting of a second configuration for activation of the at least one determined slot.

In accordance with another example embodiment, a non-transitory program storage device readable by a machine may be provided, tangibly embodying instructions executable by the machine for performing operations, the operations comprising: causing receiving, with a second apparatus, of a first configuration of one or more candidate slots; causing receiving, from a first apparatus, of at least one preparation reference signal; determining at least one slot of the one or more candidate slots based, at least partially, on at least one of: the first configuration, or the at least one preparation reference signal; and causing transmitting of a second configuration for activation of the at least one determined slot.

In accordance with another example embodiment, a non-transitory computer-readable medium comprising instructions that, when executed by an apparatus, cause the apparatus to perform at least the following: causing receiving, with a second apparatus, of a first configuration of one or more candidate slots; causing receiving, from a first apparatus, of at least one preparation reference signal; determining at least one slot of the one or more candidate slots based, at least partially, on at least one of: the first configuration, or the at least one preparation reference signal; and causing transmitting of a second configuration for activation of the at least one determined slot.

A computer implemented system comprising: at least one processor and at least one non-transitory memory storing instructions that, when executed by the at least one processor, cause the system at least to perform: causing receiving, with a second apparatus, of a first configuration of one or more candidate slots; causing receiving, from a first apparatus, of at least one preparation reference signal; determining at least one slot of the one or more candidate slots based, at least partially, on at least one of: the first configuration, or the at least one preparation reference signal; and causing transmitting of a second configuration for activation of the at least one determined slot.

A computer implemented system comprising: means for causing receiving, with a second apparatus, of a first configuration of one or more candidate slots; means for causing receiving, from a first apparatus, of at least one preparation reference signal; means for determining at least one slot of the one or more candidate slots based, at least partially, on at least one of: the first configuration, or the at least one preparation reference signal; and means for causing transmitting of a second configuration for activation of the at least one determined slot.

In accordance with one example embodiment, an apparatus may comprise: at least one processor; and at least one memory storing instructions that, when executed by the at least one processor, cause the apparatus at least to: transmit, to a first apparatus, a first configuration of one or more candidate slots; and transmit, to a second apparatus associated with a third apparatus, a second configuration of one or more candidate slots.

The apparatus may comprise a fourth apparatus, and may comprise a session control unit.

The first apparatus may comprise an activator.

The second apparatus may comprise a reader.

The third apparatus may comprise a tag.

The first configuration may further comprise a configuration for transmitting at least one preparation reference signal.

The first configuration may be transmitted via at least one of: a radio resource control information element, or a medium access control message.

The second configuration may further comprise a configuration for receiving at least one preparation reference signal.

The second configuration may further comprise a configuration for determining at least one slot of the one or more candidate slots.

The second configuration may be transmitted via at least one of: a radio resource control information element, or a medium access control message.

The example apparatus may be further configured to: receive, from the second apparatus, a third configuration for activation of at least one slot of the one or more candidate slots.

The third configuration may comprise an index of the at least one slot.

The second configuration may further comprise at least one of: a configuration for updating at least one estimate of a channel between the first apparatus and the second apparatus, or a configuration for updating at least one time-selectivity information associated with the channel.

In accordance with one aspect, an example method may be provided comprising: transmitting, with a fourth apparatus to a first apparatus, a first configuration of one or more candidate slots; and transmitting, to a second apparatus associated with a third apparatus, a second configuration of one or more candidate slots.

The fourth apparatus may comprise a session control unit.

The first apparatus may comprise an activator.

the second apparatus may comprise a reader.

The third apparatus may comprise a tag.

The first configuration may further comprise a configuration for transmitting at least one preparation reference signal.

The first configuration may be transmitted via at least one of: a radio resource control information element, or a medium access control message.

The second configuration may further comprise a configuration for receiving at least one preparation reference signal.

The second configuration may further comprise a configuration for determining at least one slot of the one or more candidate slots.

The second configuration may be transmitted via at least one of: a radio resource control information element, or a medium access control message.

The example method may further comprise: receiving, from the second apparatus, a third configuration for activation of at least one slot of the one or more candidate slots.

The third configuration may comprise an index of the at least one slot.

The second configuration may further comprise at least one of: a configuration for updating at least one estimate of a channel between the first apparatus and the second apparatus, or a configuration for updating at least one time-selectivity information associated with the channel.

In accordance with one example embodiment, an apparatus may comprise: circuitry configured to perform: transmitting, to a first apparatus, a first configuration of one or more candidate slots; and circuitry configured to perform: transmitting, to a second apparatus associated with a third apparatus, a second configuration of one or more candidate slots.

In accordance with one example embodiment, an apparatus may comprise: processing circuitry; memory circuitry including computer program code, the memory circuitry and the computer program code configured to, with the processing circuitry, enable the apparatus to: transmit, to a first apparatus, a first configuration of one or more candidate slots; and transmit, to a second apparatus associated with a third apparatus, a second configuration of one or more candidate slots.

In accordance with one example embodiment, an apparatus may comprise means for: transmitting, to a first apparatus, a first configuration of one or more candidate slots; and transmitting, to a second apparatus associated with a third apparatus, a second configuration of one or more candidate slots.

The apparatus may comprise a fourth apparatus, and may comprise a session control unit.

The first apparatus may comprise an activator.

The second apparatus may comprise a reader.

The third apparatus may comprise a tag.

The first configuration may further comprise a configuration for transmitting at least one preparation reference signal.

The first configuration may be transmitted via at least one of: a radio resource control information element, or a medium access control message.

The second configuration may further comprise a configuration for receiving at least one preparation reference signal.

The second configuration may further comprise a configuration for determining at least one slot of the one or more candidate slots.

The second configuration may be transmitted via at least one of: a radio resource control information element, or a medium access control message.

The means may be further configured for: receiving, from the second apparatus, a third configuration for activation of at least one slot of the one or more candidate slots.

The third configuration may comprise an index of the at least one slot.

The second configuration may further comprise at least one of: a configuration for updating at least one estimate of a channel between the first apparatus and the second apparatus, or a configuration for updating at least one time-selectivity information associated with the channel.

In accordance with one example embodiment, a non-transitory computer-readable medium comprising instructions stored thereon which, when executed with at least one processor, cause the at least one processor to: cause transmitting, to a first apparatus, of a first configuration of one or more candidate slots; and cause transmitting, to a second apparatus associated with a third apparatus, of a second configuration of one or more candidate slots.

In accordance with one example embodiment, a non-transitory computer-readable medium comprising program instructions stored thereon for performing at least the following: causing transmitting, to a first apparatus, of a first configuration of one or more candidate slots; and causing transmitting, to a second apparatus associated with a third apparatus, of a second configuration of one or more candidate slots.

In accordance with another example embodiment, a non-transitory program storage device readable by a machine may be provided, tangibly embodying instructions executable by the machine for performing operations, the operations comprising: causing transmitting, to a first apparatus, of a first configuration of one or more candidate slots; and causing transmitting, to a second apparatus associated with a third apparatus, of a second configuration of one or more candidate slots.

In accordance with another example embodiment, a non-transitory computer-readable medium comprising instructions that, when executed by an apparatus, cause the apparatus to perform at least the following: causing transmitting, to a first apparatus, of a first configuration of one or more candidate slots; and causing transmitting, to a second apparatus associated with a third apparatus, of a second configuration of one or more candidate slots.

A computer implemented system comprising: at least one processor and at least one non-transitory memory storing instructions that, when executed by the at least one processor, cause the system at least to perform: causing transmitting, to a first apparatus, of a first configuration of one or more candidate slots; and causing transmitting, to a second apparatus associated with a third apparatus, of a second configuration of one or more candidate slots.

A computer implemented system comprising: means for causing transmitting, to a first apparatus, of a first configuration of one or more candidate slots; and means for causing transmitting, to a second apparatus associated with a third apparatus, of a second configuration of one or more candidate slots.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. A first apparatus comprising:
at least one processor; and
at least one non-transitory memory storing instructions that, when executed by the at least one processor, cause the first apparatus at least to:
receive a first configuration of one or more candidate slots;
receive a second configuration for activation of at least one slot of the one or more candidate slots; and
transmit at least one activation signal in the at least one activated slot.

2. The first apparatus of claim 1, wherein the first apparatus comprises an activator.

3. The first apparatus of claim 1, wherein the at least one memory stores instructions that, when executed by the at least one processor, cause the first apparatus to:
transmit, to a second apparatus, at least one preparation reference signal based, at least partially, on the first configuration.

4. The first apparatus of claim 3, wherein the at least one preparation reference signal identifies the first apparatus.

5. The first apparatus of claim 3, wherein the first configuration comprises a configuration for the at least one preparation reference signal.

6. The first apparatus of claim 1, wherein the second configuration comprises, at least, an index of the at least one slot.

7. The first apparatus of claim 1, wherein the first configuration comprises, at least, an indication to monitor for the second configuration.

8. The first apparatus of claim 1, wherein the first configuration is received via at least one of:
a radio resource control information element, or
a medium access control message.

9. The first apparatus of claim 1, wherein the second configuration is received via at least one of:
a radio resource control information element, or
a medium access control message.

10. The first apparatus of claim 1, wherein the first configuration is received from a session control unit.

11. The first apparatus of claim 1, wherein the at least one activation signal is transmitted to a third apparatus associated with the first apparatus.

12. The first apparatus of claim 11, wherein the third apparatus comprises a tag.

13. The first apparatus of claim 1, wherein the second configuration is received from a second apparatus associated with the first apparatus.

14. The first apparatus of claim 13, wherein the second apparatus comprises a reader.

15. A second apparatus comprising:
at least one processor; and
at least one non-transitory memory storing instructions that, when executed by the at least one processor, cause the second apparatus at least to:
receive a first configuration of one or more candidate slots;
receive, from a first apparatus, at least one preparation reference signal;
determine at least one slot of the one or more candidate slots based, at least partially, on at least one of:
the first configuration, or
the at least one preparation reference signal; and
transmit a second configuration for activation of the at least one determined slot.

16. The second apparatus of claim 15, wherein the second apparatus comprises a reader, and the first apparatus comprises an activator.

17. The second apparatus of claim 15, wherein the second configuration comprises, at least, an index of the at least one determined slot.

18. The second apparatus of claim 15, wherein the first configuration comprises at least one of:
an indication to monitor for the at least one preparation reference signal, or
a configuration for determining the at least one slot.

19. The second apparatus of claim 15, wherein determining the at least one slot comprises the at least one memory stores instructions that, when executed by the at least one processor, cause the second apparatus to:
determine one or more conditions of a channel between the first apparatus and the second apparatus;
determine a combiner configured to at least one of:
minimize a contribution of at least one activation signal in at least one of the one or more candidate slots, or
isolate the at least one activation signal in the at least one of the one or more candidate slots; and
determine the at least one slot based, at least partially, on the one or more determined channel conditions.

20. A fourth apparatus comprising:
at least one processor; and
at least one non-transitory memory storing instructions that, when executed by the at least one processor, cause the fourth apparatus at least to:
transmit, to a first apparatus, a first configuration of one or more candidate slots; and
transmit, to a second apparatus associated with a third apparatus, a second configuration of one or more candidate slots.
